(19) United States
(12) Patent Application Publication
(10) Pub. No.: US 2011/0255954 A1
(43) Pub. Date: Oct. 20, 2011

(54) FLUID-DRIVEN MILL

(76) Inventor: Jen-Hsin CHEN, Hualien County (TW)

(21) Appl. No.: 13/089,382

(22) Filed: Apr. 19, 2011

(30) Foreign Application Priority Data
Apr. 20, 2010 (TW) 099207192

(51) Int. Cl. F03D 3/00

(52) U.S. Cl. 415/4.2

(57) ABSTRACT

A fluid-driven mill includes: a supporting unit including a vertical shaft and a plurality of stoppers; and a plurality of vertical plate members, each of which is pivoted to the supporting unit so as to be rotatable relative to the supporting unit about a corresponding rotational axis which is parallel to a central vertical axis defined by the vertical shaft between a pushing position and a release position. The vertical plate members are angularly displaced from each other and are disposed around the central vertical axis. The stoppers are disposed between the vertical shaft and an imaginary cylindrical plane formed by the rotational axes.

### CROSS REFERENCE TO RELATED APPLICATION

This application claims priority of Taiwanese Application No. 099207192, filed on Apr. 20, 2010.

### BACKGROUND OF THE INVENTION

1. Field of the Invention

This invention relates to a fluid-driven mill, more particularly to a fluid-driven mill including a plurality of vertical plate members rotatable about vertical axes for driving rotation of the fluid-driven mill.

2. Description of the Related Art

FIG. 1 illustrates a conventional windmill adapted to be connected to a power generator (not shown) for converting wind energy into electric power. The conventional windmill includes a vertical shaft 11, a plurality of supporting rods 14 extending radially and outwardly from an upper connector 12 on a top end of the vertical shaft 11, a plurality of stopping rods 15 disposed below the supporting rods 14 and extending radially and outwardly from a lower connector 13 on the vertical shaft 11, and a plurality of fan plates 16 pivoted to and hung on the supporting rods 14 so as to be rotatable about respective horizontal axes defined by the supporting rods 14 relative to the vertical shaft 11. In operation, when wind blows in a direction (indicated as parallel arrows in FIG. 1), at least one of the fan plates 16 (also labeled as 16a) disposed at one side of the vertical shaft 11 is brought into contact with and pushes a corresponding one of the stopping rods 15, thereby resulting in a driving force that drives rotation of the vertical shaft 11 about its axis. The wind also pushes at least an opposite one of the fan plates 16 (also labeled as 16b) against a pulling force acting thereon due to gravity. Therefore, the weight of the opposite one of the fan plates 16 results in an opposite force that offsets a portion of the driving force, which in turn may stop rotation of the vertical shaft 11 about its axis when the opposite force is not smaller than the driving force. As a consequence, the conventional windmill has a relatively low efficiency of converting wind energy into electric power. In addition, for a large size conventional windmill, the weight of each fan plate 16 produces a large torque that tends to result in higher manufacturing cost for longer and stronger supporting rods 14 which can support the fan plates 16.

### SUMMARY OF THE INVENTION

Therefore, an object of the present invention is to provide a fluid-driven mill that can overcome at least one of the aforesaid drawbacks associated with the prior art.

According to the present invention, there is provided a fluid-driven mill that comprises: a supporting unit including a vertical shaft, a plurality of stoppers, and a lower seat, the vertical shaft defining a central vertical axis, the lower seat being secured to the vertical shaft, each of the stoppers being secured to the lower seat, the stoppers being angularly displaced from each other and being disposed around the central vertical axis; and a plurality of vertical plate members, each of which has a driving surface, and is pivoted to the lower seat so as to be rotatable relative to the supporting unit about a corresponding rotational axis between a pushing position, in which the driving surface is disposed adjacent to and interacts with a corresponding one of the stoppers for pushing the corresponding one of the stoppers, and a release position, in which the driving surface is away from the corresponding one of the stoppers and is released from the interaction with the corresponding one of the stoppers. The rotational axes are parallel to the central vertical axis. The vertical plate members axe angularly displaced from each other and are disposed around the central vertical axis. The stoppers are disposed between the vertical shaft and an imaginary cylindrical plane formed by the rotational axes.

### BRIEF DESCRIPTION OF THE DRAWINGS

In drawings which illustrate embodiments of the invention,

FIG. 1 is a perspective view of a conventional windmill;

FIG. 2 is an exploded perspective view of the first preferred embodiment of a fluid-driven mill according to the present invention;

FIG. 3 is an assembled perspective view of the first preferred embodiment;

FIGS. 4 and 5 are schematic views of the first preferred embodiment to illustrate consecutive states of the fluid-driven mill driven by a flowing fluid;

FIG. 6 is an exploded perspective view of the second preferred embodiment of a fluid-driven mill according to the present invention;

FIG. 7 is a schematic side view of the second preferred embodiment;

FIG. 8 is an exploded schematic view of a vertical plate member of the second preferred embodiment;

FIG. 9 is an assembled schematic view of the vertical plate member of the second preferred embodiment;

FIG. 10 is a fragmentary partly sectional view of the second embodiment, illustrating how a vertical plate member interacts magnetically with a stopper; and

FIGS. 11 and 12 are schematic views of the second preferred embodiment to illustrate consecutive states of the fluid-driven mill driven by a flowing fluid.

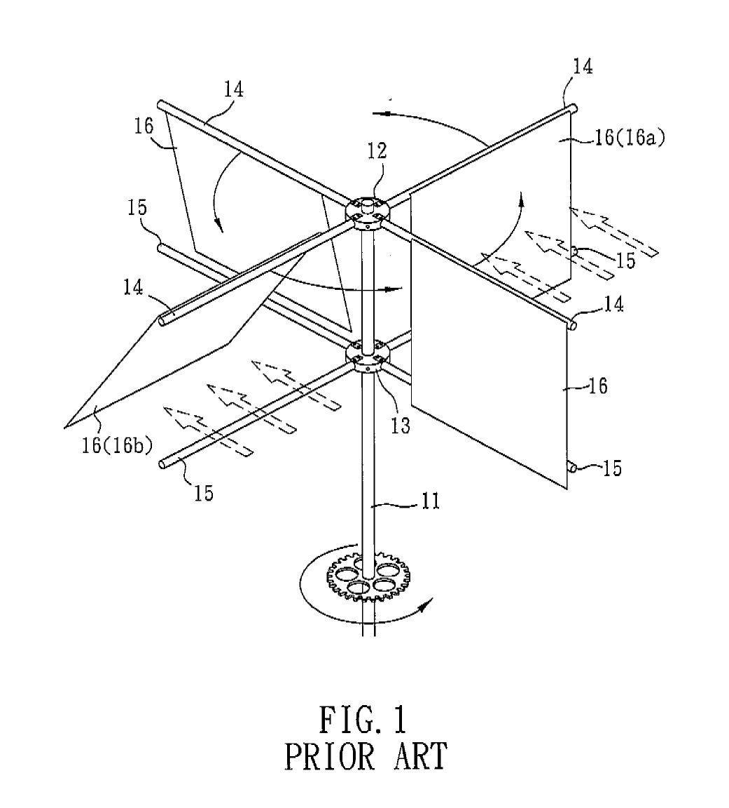

### DETAILED DESCRIPTION OF TEE PREFERRED EMBODIMENTS

Before the present invention is described in greater detail with reference to the accompanying preferred embodiments, it should be noted herein that like elements are denoted by the same reference numerals throughout the disclosure.

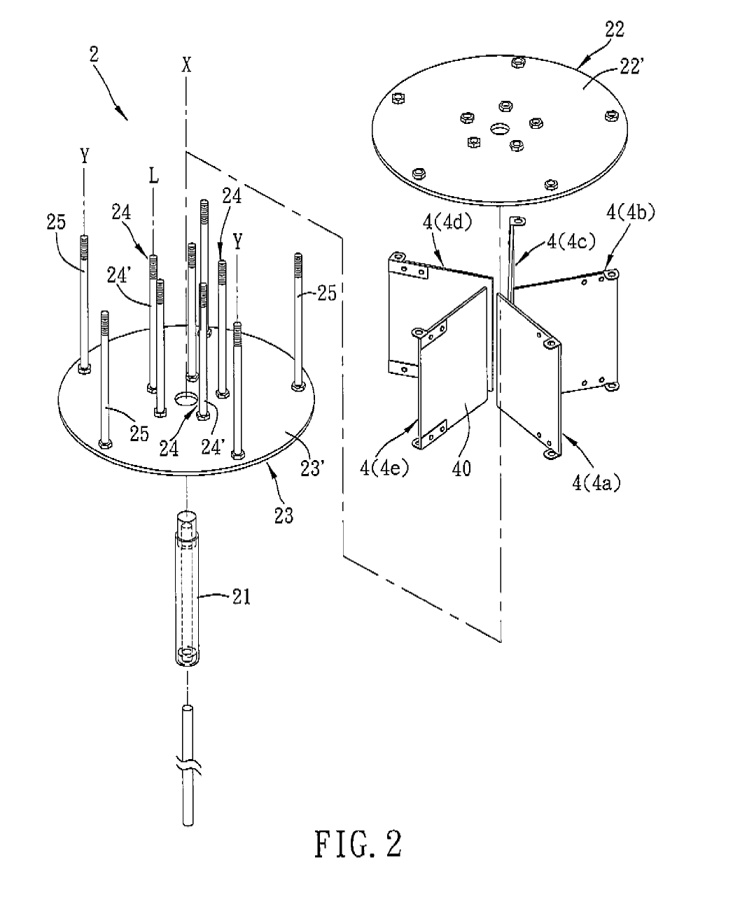

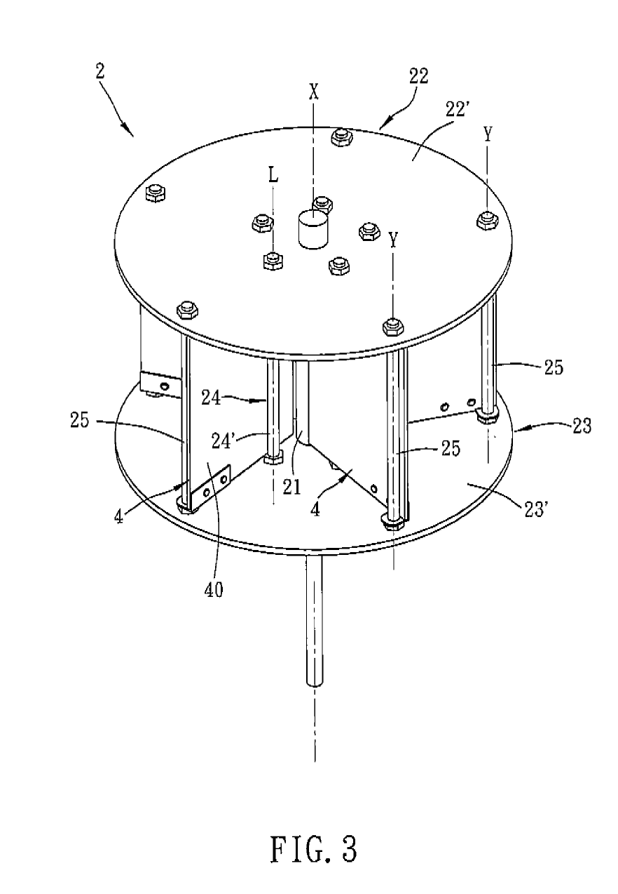

FIGS. 2 and 3 illustrate the first preferred embodiment of a fluid-driven mill according to the present invention. The fluid-driven mill is adapted to be connected to a power generator (not shown) and can be driven to rotate by a flowing fluid, such as wind, so as to convert fluid energy into electric power.

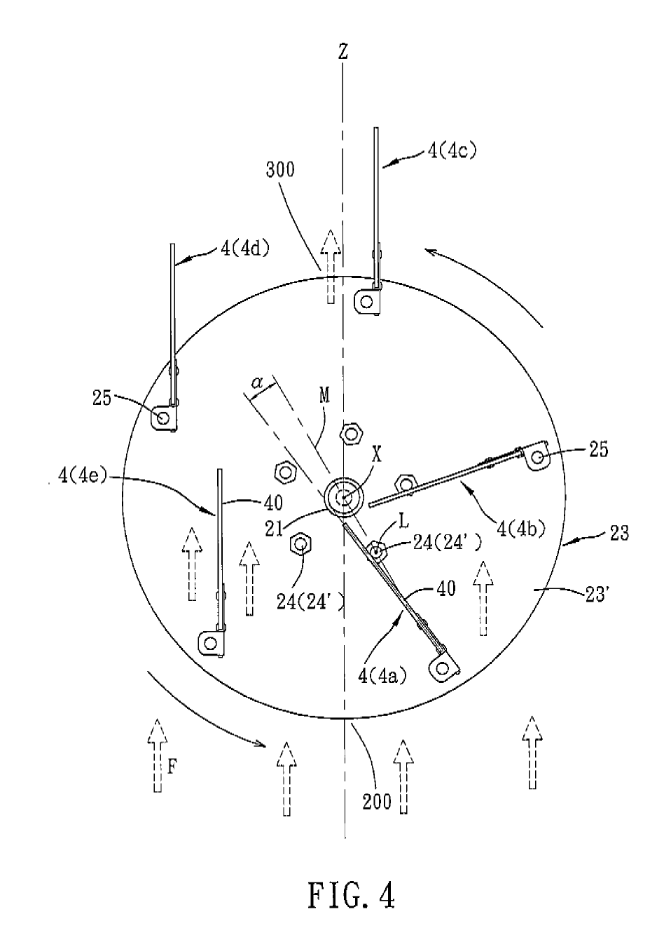

The fluid-driven mill includes: a supporting unit 2 including a vertical shaft 21, a plurality of stoppers 24, and upper and lower seats 22, 23, the vertical shaft 21 defining a central vertical axis (X), the upper and lower seats 22, 23 being secured to the vertical shaft 21 and being spaced apart from each other along the central vertical axis (X), each of the stoppers 24 being secured to the supporting unit 2 and being disposed between the upper and lower seats 22, 23, the stoppers 24 being equiangularly displaced from each other and being disposed around the central vertical axis (X); and a plurality of vertical plate members 4 (which are also labeled as 4a, 4b, 4c, 4d and 4e, for example, for distinguishing them from each other), each of which has a driving surface 40, is disposed between the upper and lower seats 22, 23, and is pivoted to the supporting unit 2 so as to be rotatable relative to the supporting unit 2 about a corresponding rotational axis (Y) between a pushing position (see the vertical plate members labeled as 4a and 4b in FIG. 4), in which the driving surface 40 of the vertical plate member 4 is disposed adjacent to and interacts with a corresponding one of the stoppers 24 by directly contacting the corresponding one of the stoppers 24 for pushing the corresponding one of the stoppers 24, thereby resulting in rotation of the supporting unit 2, and a release position (see the vertical plate members labeled as 4c, 4d and 4e in FIG. 4), in which the driving surface 40 of the vertical plate member 4 is away from the corresponding one of the stoppers and is released from the interaction with the corresponding one of the stoppers 24. The rotational axes (Y) are parallel to the central vertical axis (X) and extend in the same direction. The vertical plate members 4 are equiangularly displaced from each other and are disposed around the central vertical axis (X). The stoppers 24 are disposed between the vertical shaft 21 and an imaginary cylindrical plane formed by the rotational axes (Y).

In this embodiment, each of the stoppers 24 has a vertical rod 24′ that extends along an extending axis (L) parallel to the central vertical axis (X) and that has opposite ends secured to the upper and lower seats 22, 23, respectively. The driving surface 40 of each of the vertical plate members 4 directly contacts a corresponding one of the vertical rods 24′ when the vertical plate member 4 is at the pushing position.

Preferably, the driving surface 40 of each of the vertical plate members 4 forms an acute angle (α) (see FIG. 4) with an imaginary vertical plane (M) on which the central vertical axis (X) and the extending axis (L) of the corresponding one of the vertical rods 24′ lie when the vertical plate member 4 is at the pushing position. Preferably, the acute angle (α) ranges from 5 to 35 degrees, and more preferably from 15 to 25 degrees so as to facilitate driving rotation of the fluid-driven mill of the invention and to achieve a higher energy conversion efficiency of the fluid-driven mill.

The upper and lower seats 22, 23 have upper and lower circular panels 22′, 23′, respectively. The upper and lower circular panels 22′, 23′ are disposed coaxially with and extend radially and outwardly from the vertical shaft 21. The opposite ends of each of the vertical rods 24′ are detachably secured to the upper and lower circular panels 22′, 23′, respectively.

The supporting unit 2 further includes a plurality of pivot rods 25 defining the rotational axes (Y), respectively. Each of the pivot rods 25 has opposite ends that are detachably secured to the upper and lower circular panels 22′, 23′, respectively. The vertical plate members 4 are pivotable about the pivot rods 25, respectively.

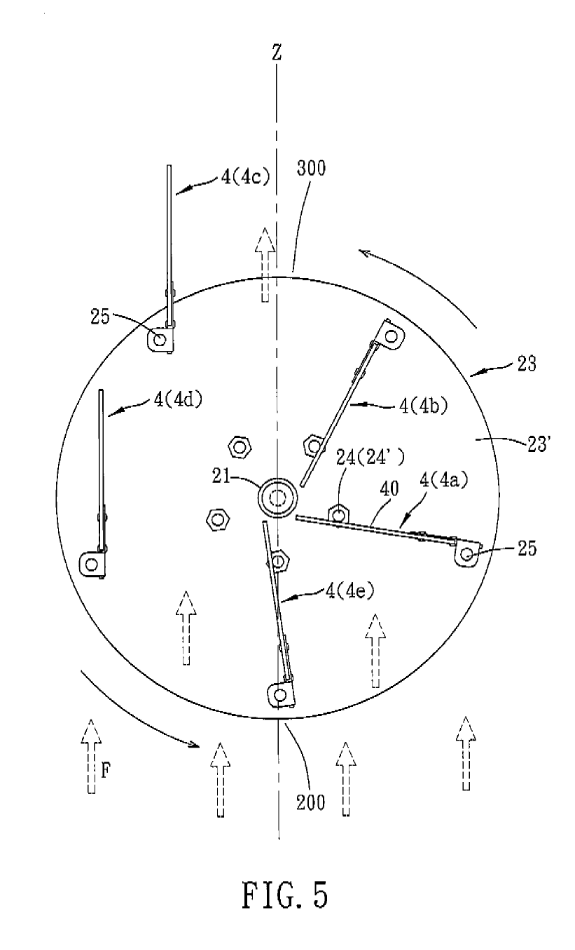

FIGS. 4 and 5 illustrate respectively consecutive first and second states of the first preferred embodiment of the fluid-driven mill driven by a fluid flowing in a direction (F). At the first state, the vertical plate members 4a and 4b are disposed at the pushing position, while the vertical plate members 4c, 4d and 4e are disposed at the release position and are substantially parallel to the flow direction (F) (note that the fluid flowing at the left-hand side and the right-hand side of each of the vertical plate members 4c, 4d and 4e will balance and maintain the vertical plate members 4c, 4d and 4e to be parallel to the flow direction (F)). At the second state, the vertical plate members 4a and 4b remain at the pushing position and the vertical plate members 4c and 4d remain at the release position and are substantially parallel to the flow direction (F), while the vertical plate member 4e is rotated to the pushing position. FIGS. 4 and 5 show that the vertical plate member 4e is gradually moved toward the corresponding one of the vertical rods 24′ by the fluid when moved to a front side 200 of the fluid-driven mill and approaching a centerline (Z) which is parallel to the flow direction (F) and which passes through the central vertical axis (X). After the second state, as the vertical plate member 4b is kept being pushed by the fluid to a rear side 300 of the fluid-driven mill at a position adjacent to the centerline (Z), it will move away from the corresponding one of the vertical rods 24′. Since those of the vertical plate members 4 that are released from contacting the corresponding stoppers 24 are instantly moved to the release position and are maintained parallel to the flow direction (F) of the fluid during operation of the fluid-driven mill, the fluid-driven mill of this invention can overcome the aforesaid drawback of generation of the opposite force that offsets the driving force as encountered in the prior art.

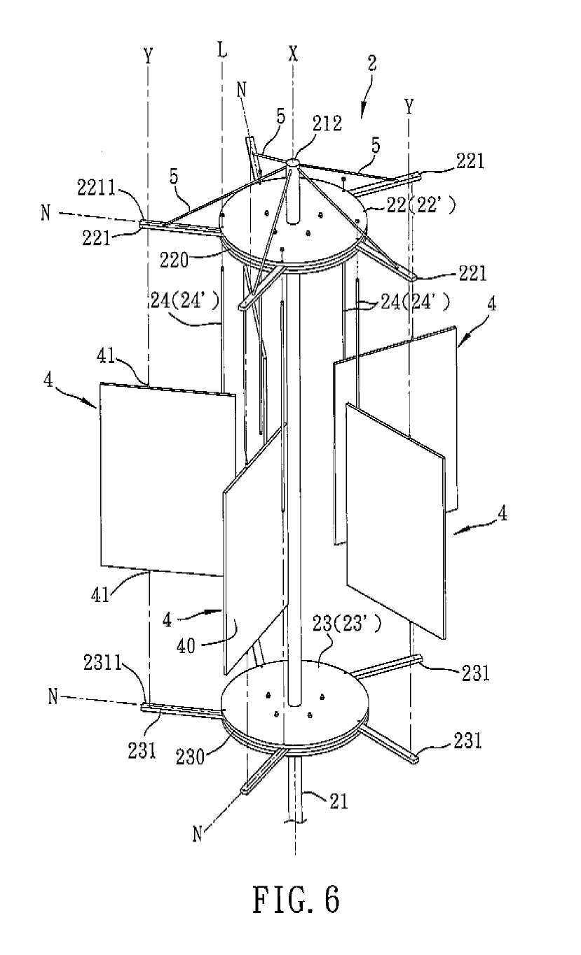

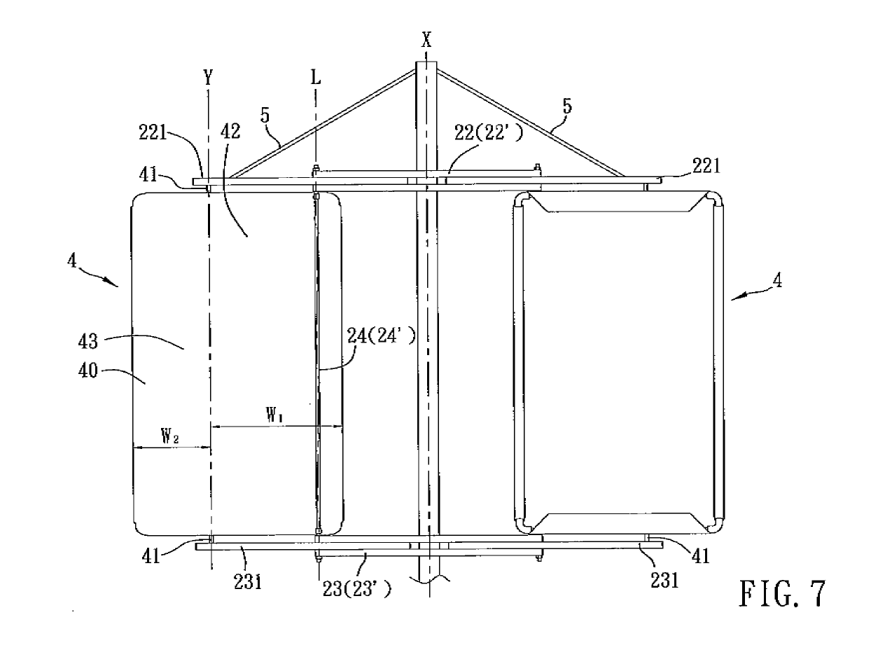

FIGS. 6 and 7 illustrate the second preferred embodiment of the fluid-driven mill according to the present invention. The fallowing paragraphs will describe major differences between this preferred embodiment and the previous embodiment for the sake of brevity. In the second preferred embodiment, the upper seat 22 includes an upper circular panel 22′ and a plurality of upper extension sticks 221 protruding outwardly from an outer edge 220 of the upper circular panel 22′ and disposed angularly around the central vertical axis (X). Each of the upper extension sticks 221 has a free end portion 2211 distal from the outer edge 220 of the upper circular panel 22′. The lower seat 23 includes a lower circular panel 23′ and a plurality of lower extension sticks 231 protruding outwardly from an outer edge 230 of the lower circular panel 23′ and disposed angularly around the central vertical axis (X). Each of the lower extension sticks 231 has a free end portion 2311 that is distal from the outer edge 230 of the lower circular panel 23′ and that is aligned with the free end portion 2211 of a corresponding one of the upper extension sticks 221 along a vertical direction parallel to a corresponding rotational axis (Y). The upper and lower circular panels 22′, 23′ are disposed coaxially with and extend radially and outwardly from the vertical shaft 21. Each of the vertical plate members 4 is pivoted to the free end portion 2211 of a corresponding one of the upper extension sticks 221 and the free end portion 2311 of a corresponding one of the lower extension sticks 231.

Each of the vertical plate members 4 is provided with upper and lower pivot studs 41 that are pivoted to the free end portion 2211 of the corresponding one of the upper extension sticks 221 and the free end portion 2311 of the corresponding one of the lower extension sticks 231, respectively, and that cooperatively define a corresponding one of the rotational axes (Y).

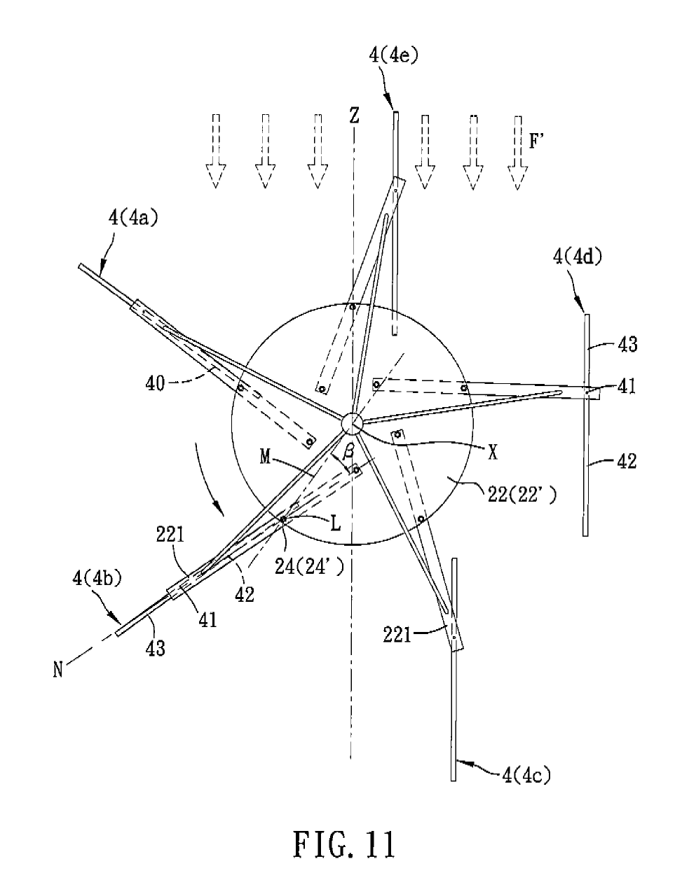

Each of the vertical plate members 4 is rectangular in shape and has first and second portions 42, 43 (see FIG. 7) divided by the corresponding one of the rotational axes (Y). The first position 42 is disposed closer to the central vertical axis (X) compared to the second portion 43. Moreover, the first portion 42 of each of the vertical plate members 4 has a width (W₁) greater than a width (W₂) of the second portion 43 and interacts with a corresponding one of the stoppers 24 (i.e., the vertical rods 24′) to push the corresponding one of the stoppers 24 when the vertical plate member 4 is at the pushing position (see FIG. 11). Preferably, the width (W₁) of the first portion 42 is two times of the width (W₂) of the second portion 43 so that each of the vertical plate members 4 can achieve a more stable and balanced support on the upper and lower extension sticks 221, 231.

Each of the upper and lower extension sticks 221, 231 extends along a corresponding axis (N) that forms an acute angle (β) (see FIG. 11) with an imaginary vertical plane (M) on which the central vertical axis (X) and the extending axis (L) of a corresponding one of the stoppers 24 lie. Preferably, the acute angle (β) ranges from 5 to 30 degrees, and more preferably from 15 to 25 degrees.

The vertical shaft 21 has an upper end portion 212 disposed above the upper circular panel 22′. The supporting unit 2 further includes a plurality of supporting beams 5, each interconnecting the upper end portion 212 of the vertical shaft 21 and a respective one of the upper extension sticks 221.

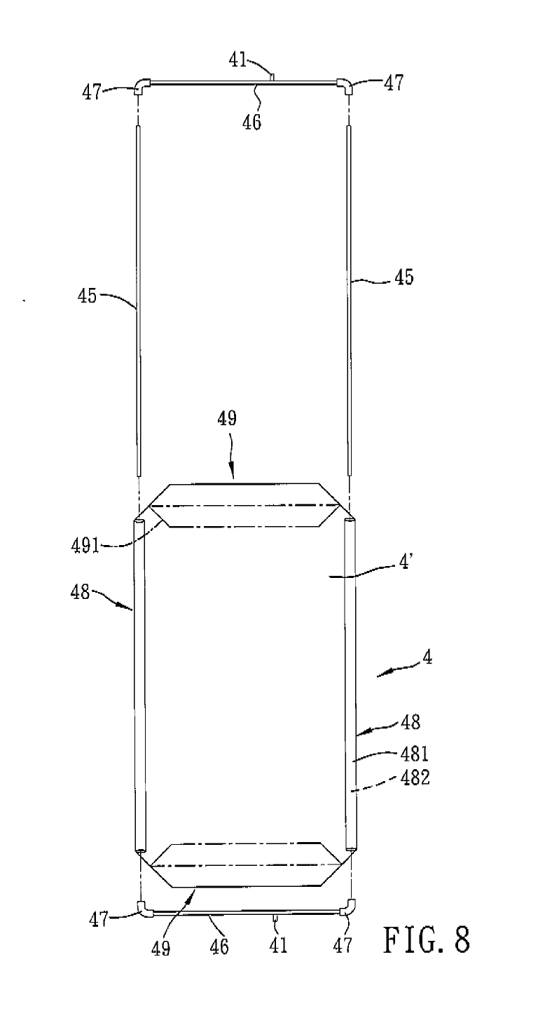

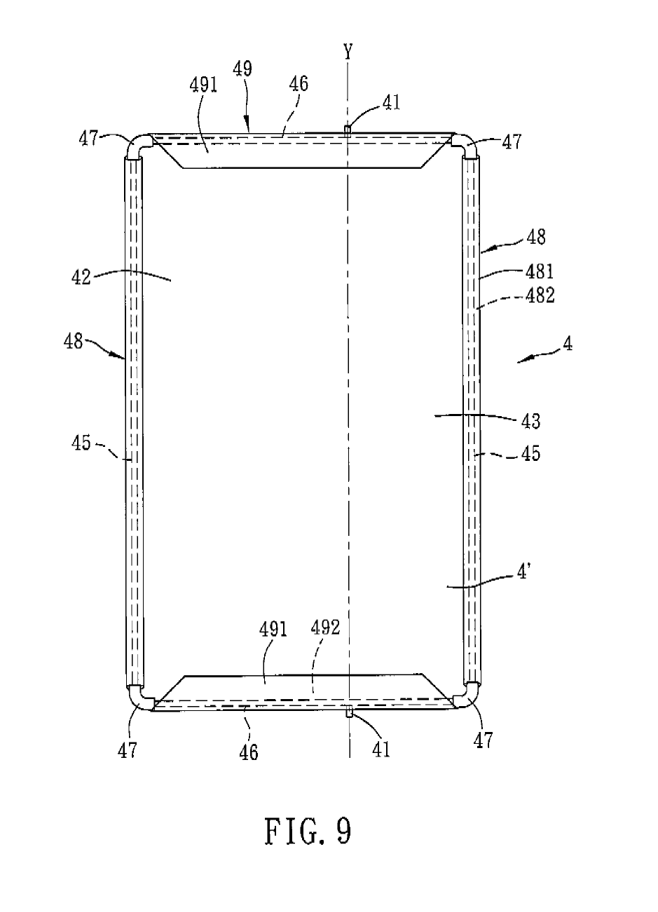

Referring to FIGS. 8 and 9, each of the vertical plate members 4 includes a rectangular plate 4′ having opposite first sides 48 and opposite second sides 49, a pair of first connecting rods 45 parallel to the central vertical axis (X), a pair of second connecting rods 46 perpendicular to the first connecting rods 45, and a plurality of rod connectors 47. Each of the first sides 48 is formed with a first folded portion 481 that defines a first inner space 482. Each of the second sides 49 is formed with a second folded portion 491 that defines a second inner space 492. The first connecting rods 45 extend into and through the first inner spaces 482 in the first folded portions 481, respectively. The second connecting rods 46 extend into and through the second inner spaces 492 in the second folded portions 491, respectively. The first connecting rods 45 are connected to the second connecting rods 46 in an end-to-end connecting manner through the rod connectors 47. One of the first connecting rods 45 is hollow and is disposed farther from the rotational axis (Y) than the other of the first connecting rods 45, while the other of the first connecting rods 45 is solid and is heavier than said one of the first connecting rods 45 so as to facilitate rotation of the vertical plate members 4.

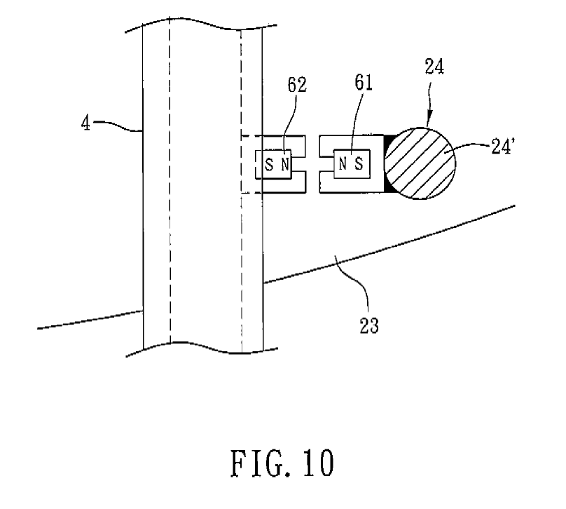

Referring to FIG. 10, the vertical rod 24′ of each of the stoppers 24 is provided with a first magnet 61. Each of the vertical plate members 4 is provided with a second magnet 62. The second magnet 62 of each of the vertical plate members 4 is disposed adjacent to and interacts with the first magnet 61 of the corresponding one of the stoppers 24 in a magnetically repulsive manner when the vertical plate member 4 is at the pushing position, thereby generating a repulsive force to push the corresponding one of the stoppers 24 without directly striking the vertical plate member 4 to the stopper 24.

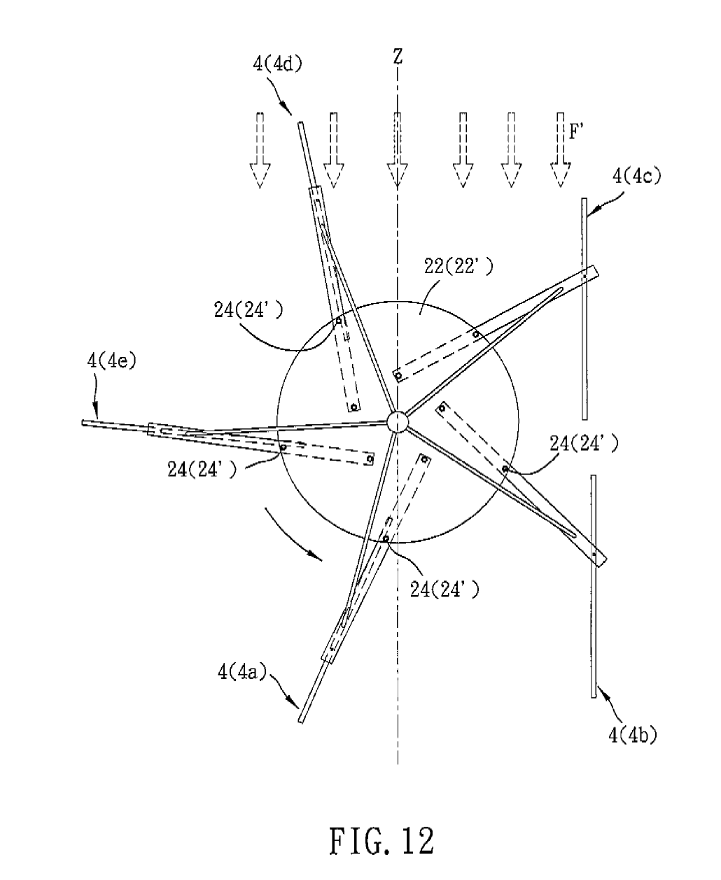

FIGS. 11 and 12 illustrate consecutive first and second states of the fluid-driven mill of the second preferred embodiment by a fluid flowing in a direction (F′). At the first state, the vertical plate members 4a and 4b are disposed at the pushing position, while the vertical plate members 4c, 9d and 9e are disposed at the release position and are substantially parallel to the flow direction (F′). At the second state, the vertical plate member 4a remains at the pushing position and the vertical plate member 4c remains at the release position and is substantially parallel to the flow direction (F′), while the vertical plate member 4b is moved from the left-hand side of the centerline (Z) to the right-hand side of the centerline (Z) and is rotated to the release position by the fluid and the vertical plate members 4d and 4e are moved from the right-hand side of the centerline (Z) to the left-hand side of the centerline (Z) and are rotated to the pushing position by the fluid.

Similar to the previous embodiment, FIGS. 11 and 12 also demonstrate that the fluid-driven mill of this invention can overcome the aforesaid drawback of generation of the opposite force that offsets the driving force as encountered in the prior art.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A fluid-driven mill, comprising:
a supporting unit including a vertical shaft, a plurality of stoppers, and a lower seat, said vertical shaft defining a central vertical axis, said lower seat being secured to said vertical shaft, each of said stoppers being secured to said lower seat, said stoppers being angularly displaced from each other and being disposed around the central vertical axis; and
a plurality of vertical plate members, each of which has a driving surface, and is pivoted to said lower seat so as to be rotatable relative to said supporting unit about a corresponding rotational axis between a pushing position, in which said driving surface is disposed adjacent to and interacts with a corresponding one of said stoppers for pushing the corresponding one of said stoppers, and a release position, in which said driving surface is away from the corresponding one of said stoppers and is released from the interaction with the corresponding one of said stoppers, the rotational axes being parallel to the central vertical axis, said vertical plate members being angularly displaced from each other and being disposed around the central vertical axis, said stoppers being disposed between said vertical shaft and an imaginary cylindrical plane formed by the rotational axes.

2. The fluid-driven mill of claim 1, wherein:
said supporting unit further includes an upper seat secured to said vertical shaft and spaced apart from said lower seat along the central vertical axis, said stoppers being disposed between said upper and lower seats; and
each of said stoppers has a vertical rod that extends along an extending axis parallel to the central vertical axis and that has opposite ends secured to said upper and lower seats, respectively.

3. The fluid-driven mill of claim 2, wherein said driving surface of each of said vertical plate members forms an acute angle with an imaginary vertical plane on which the central vertical axis and the extending axis of the corresponding one of said vertical rods lie when said vertical plate member is at the pushing position.

4. The fluid-driven mill of claim 3, wherein said driving surface of each of said vertical plate members interacts with the corresponding one of said vertical rods to push the corresponding one of said vertical rods by directly contacting the corresponding one of said vertical rods when said vertical plate member is at the pushing position.

5. The fluid-driven mill of claim 3, wherein said upper and lower seats have upper and lower circular panels, respectively, said upper and lower circular panels being disposed coaxially with and extending radially and outwardly from said vertical shaft, said opposite ends of each of said vertical rods being secured to said upper and lower circular panels, respectively.

6. The fluid-driven mill of claim 5, wherein said supporting unit further includes a plurality of pivot rods defining said rotational axes, respectively, each of said pivot rods having opposite ends that are secured to said upper and lower circular panels, respectively, said vertical plate members being pivotable about said pivot rods, respectively.

7. The fluid-driven mill of claim 1, wherein:
said supporting unit further includes an upper seat secured to said vertical shaft and spaced apart from said lower seat along the central vertical axis, said stoppers being disposed between said upper and lower seats; and
said upper seat includes an upper circular panel and a plurality of upper extension sticks protruding outwardly from an outer edge of said upper circular panel, each of said upper extension sticks having a free end portion, said lower seat including a lower circular panel and a plurality of lower extension sticks protruding outwardly from an outer edge of said lower circular panel, each of said lower extension sticks having a free end portion that is aligned with said free end portion of a corresponding one of said upper extension sticks along a vertical direction parallel to a corresponding rotational axis, said upper and lower circular panels being disposed coaxially with and extending radially and outwardly from said vertical shaft, each of said vertical plate members being pivoted to said free end portion of a corresponding one of said upper extension sticks and said free end portion of a corresponding one of said lower extension sticks.

8. The fluid-driven mill of claim 7, wherein each of said vertical plate members is provided with upper and lower pivot studs that are pivoted to said free end portion of the corresponding one of said upper extension sticks and said free end portion of the corresponding one of said lower extension sticks, respectively, and that cooperatively define a corresponding one of the rotational axes.

9. The fluid-driven mill of claim 8, wherein each of said vertical plate members is rectangular in shape and has first and second portions divided by the corresponding one of the rotational axes, said first portion of each of said vertical plate members having a width greater than that of said second portion and interacting with the corresponding one of said stoppers to push the corresponding one of said stoppers when said vertical plate member is at the pushing position.

10. The fluid-driven mill of claim 7, wherein each of said stoppers has a vertical rod that extends along an extending axis parallel to the central vertical axis and that has opposite ends secured to said upper and lower circular panels, respectively.

11. The fluid-driven mill of claim 10, wherein each of said upper and lower extension sticks forms an acute angle with an imaginary vertical plane on which the central vertical axis and the extending axis of a corresponding one of said stoppers lie.

12. The fluid-driven mill of claim 7, wherein said vertical shaft has an upper end portion disposed above said upper circular panel, said supporting unit further including a plurality of supporting beams, each interconnecting said upper end portion of said vertical shaft and a respective one of said upper extension sticks.

13. The fluid-driven mill of claim 1, wherein each of said stoppers is provided with a first magnet, each of said vertical plate members being provided with a second magnet, said second magnet of each of said vertical plate members being disposed adjacent to and interacting with said first magnet of the corresponding one of said stoppers in a magnetically repulsive manner when said vertical plate member is at the pushing position.

14. The fluid-driven mill of claim 1, wherein each of said vertical plate members includes a rectangular plate having opposite first sides and opposite second sides, a pair of first connecting rods parallel to the central vertical axis, a pair of second connecting rods perpendicular to said first connecting rods, and a plurality of rod connectors, each of said first sides being formed with a first folded portion that defines a first inner space, each of said second sides being formed with a second folded portion that defines a second inner space, said first connecting rods extending into and through said first inner spaces in said first folded portions, respectively, said second connecting rods extending into and through said second inner spaces in said second folded portions, respectively, said first connecting rods being connected to said second connecting rods in an end-to-end connecting manner through said rod connectors.

15. The fluid-driven mill of claim 14, wherein one of said first connecting rods is hollow and is disposed farther from the corresponding rotational axis than the other of said first connecting rods, and the other of said first connecting rods is solid and heavier than said one of said first connecting rods.
